(19) United States
(12) Patent Application Publication
(10) Pub. No.: US 2011/0123808 A1
(43) Pub. Date: May 26, 2011

(54) INSULATOR AND MANUFACTURING METHOD FOR PRINTED CIRCUIT BOARD HAVING ELECTRO COMPONENT

(75) Inventors: Sang-Chul Lee, Anyang-si (KR); Yul-Kyo Chung, Yongin-si (KR); Doo-hwan Lee, Euijungboo-si (KR); Sang-Jin Baek, Boeun-gu (KR)

(73) Assignee: SAMSUNG ELECTRO-MECHANICS CO., LTD.

(21) Appl. No.: 12/774,432

(22) Filed: May 5, 2010

(30) Foreign Application Priority Data
Nov. 24, 2009 (KR) 10-2009-0114119

(51) Int. Cl. B32B 9/04; B29C 65/52; B32B 27/00

(52) U.S. Cl. 428/411.1; 156/60

(57) ABSTRACT

An insulator and a manufacturing method of an electronic component embedded printed circuit board using the insulator are disclosed. The method includes providing a core board having a circuit pattern formed on a surface thereof, in which the core board is penetrated by a cavity, adhering an adhesive layer covering the cavity to a lower surface of the core board, disposing an electronic component on an upper surface of the adhesive layer, in which the upper surface corresponds to the cavity, and stacking an insulator on an upper surface of the core board so as to fill the cavity, in which the insulator has an upper resin layer and a lower resin layer formed on an upper surface and a lower surface of a reinforcing material, respectively. The insulator has an asymmetric structure in which the lower resin layer is thicker than the upper resin layer.

### CROSS-REFERENCE TO RELATED APPLICATIONS

This application claims the benefit of Korean Patent Application No. 10-2009-0114119, filed with the Korean Intellectual Property Office on Nov. 24, 2009, the disclosure of which is incorporated herein by reference in its entirety.

### BACKGROUND

1. Technical Field

The present invention relates to an insulator, an electronic component embedded printed circuit board and a manufacturing method of the printed circuit board.

2. Description of the Related Art

With the development of the electronic industry, there is a growing demand for smaller and higher functional electronic components. Particularly, the trend of the market, based on lighter, thinner, shorter and smaller personal mobile devices, has resulted in thinner printed circuit boards. Emerging as a result are ways of mounting the components that are different from the conventional methods. One example is an embedded printed circuit board, in which an active device such as an IC or a passive device such as an MLCC capacitor is mounted inside the printed circuit board, resulting in a higher density of devices and improved reliability or improved performance of the package itself through a systematic combination of these.

The present invention is contrived to solve problems, such as described below, caused by embedding a thick electronic component during the fabrication of a component-embedded printed circuit board.

In the related art, when an electronic component, for example, a Multi-Layer Ceramic Capacitor (MLCC), with a thickness of 200 um˜1000 um or less is embedded in a core board, an electronic component 30 is embedded by using an adhesive layer 20 in a core board 10 in which a cavity 14 and a circuit 12 are formed, as shown in FIG. 1, and then an insulator 40 made of resin 42 filled with glass fiber 44 is stacked to improve the warpage of the board. In this case, however, the electronic component 30 becomes thicker, and the space around the electronic component and the via holes are not completely filled with the resin 42 of the insulator, as illustrated in FIG. 2. This creates a void 50 in the board and results in poor reliability, requiring improvement.

To solve the above problem, a method of using an insulator 40′ including thick resin 42′ has been suggested, as illustrated in FIG. 3, but this method undesirably increased the overall thickness of the printed circuit board, as illustrated in FIG. 4.

### SUMMARY

The present invention provides an electronic component embedded printed circuit board and a manufacturing method of the printed circuit board that can, even in case a lay-up process is performed by using a thin insulator, prevent a void, caused by degradation of resin content, around an electronic component and between circuit patterns and solve a problem in which the electronic component is deformed by a backing material filled in the insulator during the lay-up process.

An aspect of the present invention provides a manufacturing method of an electronic component embedded printed circuit board that includes providing a core board having a circuit pattern formed on a surface thereof, in which the core board is penetrated by a cavity, adhering an adhesive layer to a lower surface of the core board, in which the adhesive layer covers the cavity, disposing an electronic component on an upper surface of the adhesive layer, in which the upper surface corresponds to the cavity, and stacking an insulator on an upper surface of the core board so as to fill the cavity, in which the insulator has an upper resin layer and a lower resin layer formed on an upper surface and a lower surface of a reinforcing material, respectively. Here, the insulator has an asymmetric structure in which the lower resin layer is thicker than the upper resin layer.

Another aspect of the present invention provides an insulator that is used in manufacturing a printed circuit board. In accordance with an embodiment of the present invention, the insulator includes an upper resin layer and a lower resin layer stacked on an upper surface and a lower surface of a reinforcing material, respectively. Here, the lower resin layer is thicker than the upper resin layer.

The lower resin layer can be two to five times thicker than the upper resin layer.

Additional aspects and advantages of the present invention will be set forth in part in the description which follows, and in part will be obvious from the description, or may be learned by practice of the invention.

### BRIEF DESCRIPTION OF THE DRAWINGS

FIGS. 1 to 4 show a method of manufacturing an electronic component embedded printed circuit board in accordance with the related art.

FIG. 5 is a flowchart illustrating a method of manufacturing an electronic component embedded printed circuit board in accordance with an embodiment of the present invention.

FIGS. 6 to 10 show a method of manufacturing an electronic component embedded printed circuit board in accordance with an embodiment of the present invention.

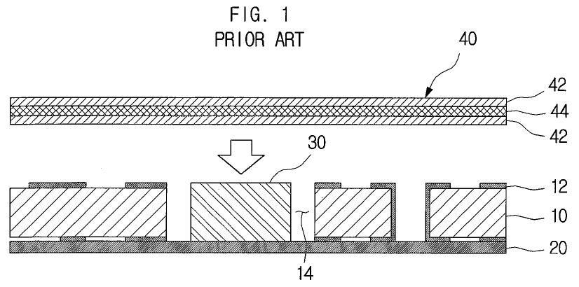

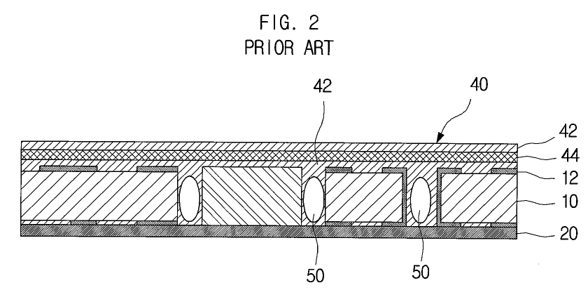

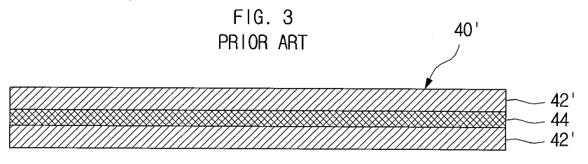

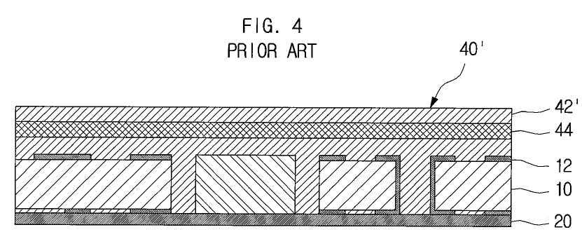

### DETAILED DESCRIPTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention.

A method of manufacturing an electronic component embedded printed circuit board according to certain embodiments of the present invention will be described below in more detail with reference to the accompanying drawings. Those components that are the same or are in correspondence are rendered the same reference numeral regardless of the figure number, and redundant descriptions are omitted.

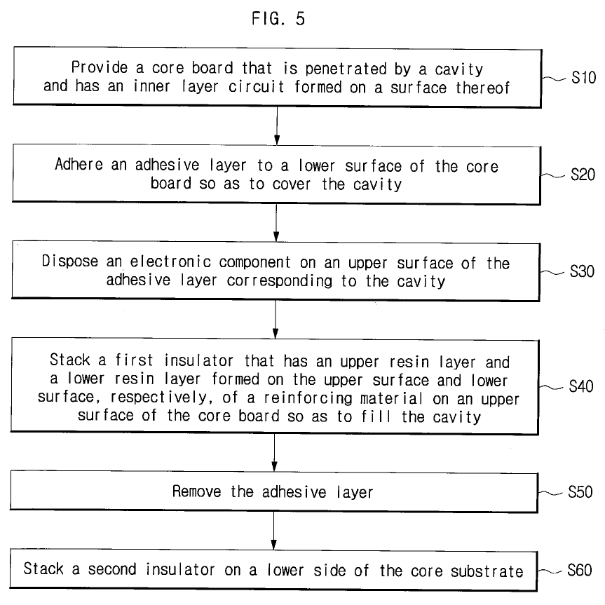

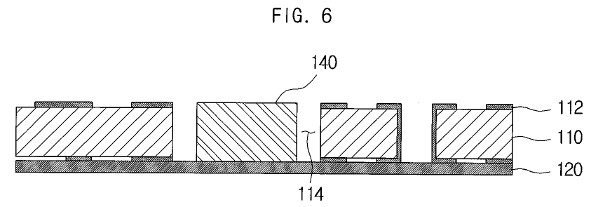

FIG. 5 is a flowchart illustrating a method of manufacturing an electronic component embedded printed circuit board in accordance with an embodiment of the present invention, and FIGS. 6 to 10 show a method of manufacturing an electronic component embedded printed circuit board in accordance with an embodiment of the present invention.

First, as illustrated in FIG. 6, a core board 110, which is penetrated by a cavity 114 and has an inner layer circuit 112 formed on a surface thereof, is prepared (S10). Then, an adhesive layer 120 is adhered to a lower surface of the core board 110 so as to cover the cavity 114 (S20). A copper-clad laminate (CCL), for example, can be used as the core board 110, and an epoxy resin in which glass fibers are impregnated can also be used to reinforce the rigidity. The inner layer circuit 112 is formed on a surface of the core board 110.

In case a copper-clad laminate is used as the core board 110, a seed layer can be formed on both surfaces of the copper-clad laminate by way of electroless plating to form the inner layer circuit 112 on its both surfaces, and then a circuit pattern can be formed by way of electroplating selectively. In another example, the inner layer circuit 112 can be formed by etching a portion of a copper film formed on both surfaces of the copper-clad laminate.

The cavity 114 is formed in a certain portion (for example, a center portion) of the core board 110. The cavity 114 is a space in which an electronic component 140 is to be mounted and can be formed by using a mechanical drill or a laser drill. A lower side of the cavity 114 can be covered by the adhesive layer 120.

Then, the electronic component 140 is disposed on an upper surface of the adhesive layer 120 corresponding to the cavity 114 (S30, refer to FIG. 6). By disposing the electronic component 140 in this way, the electronic component 140 can be adhered and fixed to an upper surface of the adhesive layer 120 that is exposed through the cavity 114.

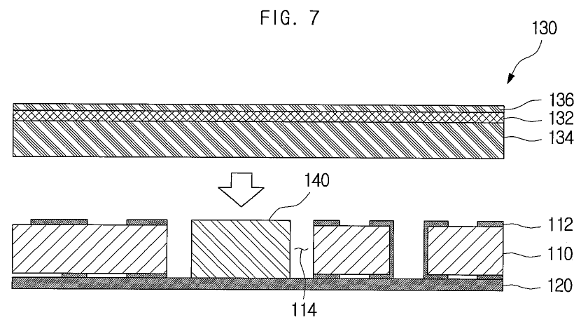

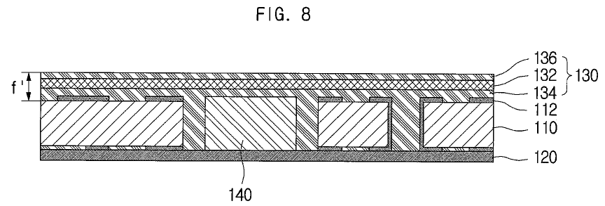

Next, a first insulator 130 that has an upper resin layer 136 and a lower resin layer 134 formed on the upper surface and lower surface, respectively, of a reinforcing material 132 is stacked on an upper surface of the core board 110 so as to fill the cavity 114 (S40, refer to FIGS. 7 and 8). Here, the first insulator 130 stacked on the upper surface of the core board 110 has an asymmetric structure in which the lower resin layer 134 is thicker than the upper resin layer 136.

By stacking the first insulator 130, in which the lower resin layer 134 is thicker than the upper resin layer 136, on the upper surface of the core board 110 having the inner circuit 112 formed thereon, not only can the electronic component 140 be fixed because the remaining space of the cavity 114 is filled by the relatively thicker lower resin layer 134, but the inside of the via hole can be also filled by the lower resin layer 134. The inner circuit 112 formed on the upper surface of the core board 110 is also covered by the lower resin layer 134.

Furthermore, if all electrodes (not shown) of the electronic component 140 are disposed facing upward (that is, if the electronic component 140 is mounted in a face-up manner), the electrodes (not shown) of the electronic component 140 can also be covered by the lower resin layer 134.

As such, if the asymmetrically structured first insulator 130, in which the lower resin layer 134 is thicker than the upper resin layer 136, is used, all of the remaining space inside the cavity 114, the space inside the via holes, the space between the inner circuits 112 and the space between the inner circuits 112 and the electrodes of the electronic component 140 can be filled, thereby preventing any void from being formed in the cavity 114, the via holes, the space between the inner circuits 112 and the space between the inner circuits 112 and/or the electrodes (not shown) of the electronic component 140.

Here, it is preferable that the lower resin layer 134 is two to five times thicker than the upper resin layer 136. If the lower resin layer 134 is two to five times thicker than the upper resin layer 136, there is a less chance of void caused by an inadequate amount of resin. At the same time, the overall thickness of the printed circuit board can be prevented from being undesirably increased.

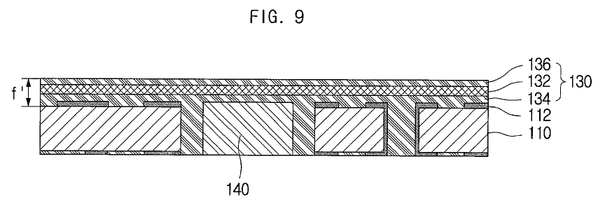

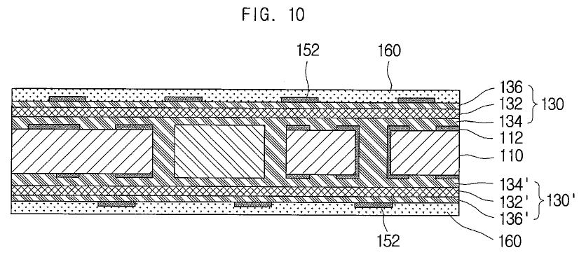

After the adhesive layer 120 is removed (S50) as illustrated in FIG. 9, a second insulator 130′ is stacked on a lower side of the core substrate 110 (S60) as illustrated in FIG. 10. Here, a reinforcing material 132′ such as glass fiber can be either impregnated or not impregnated in the second insulator 130′. As illustrated in FIG. 10, if the reinforcing material 132′ is filled in the second insulator 130′, the resin layers 134′ and 136′ stacked on either surface of the reinforcing material 132′ can have a same thickness, or can have a different thickness if necessary.

Then, as illustrated in FIG. 10, a circuit pattern 162 is formed on the surface of the first insulator 130 and on the surface of the second insulator 130′. The circuit pattern 162 formed on the surfaces of the first insulator 130 and the second insulator 130′ can be protected by the solder resist 160. Of course, if a printed circuit board with more layers is to be manufactured, additional lay-up processes can be performed without directly forming the solder resist 160.

While the spirit of the present invention has been described in detail with reference to particular embodiments, the embodiments are for illustrative purposes only and shall not limit the present invention. It is to be appreciated that those skilled in the art can change or modify the embodiments without departing from the scope and spirit of the present invention.

As such, many embodiments other than those set forth above can be found in the appended claims.

What is claimed is:

1. A method of manufacturing an electronic component embedded printed circuit board, the method comprising:
providing a core board having a circuit pattern formed on a surface thereof, the core board being penetrated by a cavity;
adhering an adhesive layer to a lower surface of the core board, the adhesive layer covering the cavity;
disposing an electronic component on an upper surface of the adhesive layer, the upper surface corresponding to the cavity; and
stacking an insulator on an upper surface of the core board so as to fill the cavity, the insulator having an upper resin layer and a lower resin layer formed on an upper surface and a lower surface of a reinforcing material, respectively;
wherein the insulator has an asymmetric structure in which the lower resin layer is thicker than the upper resin layer.

2. The method of claim 1, wherein the lower resin layer is two to five times thicker than the upper resin layer.

3. An insulator used in manufacturing a printed circuit board, the insulator comprising an upper resin layer and a lower resin layer stacked on an upper surface and a lower surface of a reinforcing material, respectively,
wherein the lower resin layer is thicker than the upper resin layer.

4. The method of claim 3, wherein the lower resin layer is two to five times thicker than the upper resin layer.
